(19) United States
(12) Patent Application Publication
(10) Pub. No.: US 2022/0329506 A1
(43) Pub. Date: Oct. 13, 2022

(54) SYSTEM AND METHOD TO REINFORCE FOGGING FOR LATENCY CRITICAL IOT APPLICATIONS IN 5G

(71) Applicant: Telefonaktiebolaget LM Ericsson (publ), Stockholm (SE)

(72) Inventors: Perepu SATHEESH KUMAR, Chennai (IN); Saravanan M, Chennai (IN)

(73) Assignee: Telefonaktiebolaget LM Ericsson (publ), Stockholm (SE)

(21) Appl. No.: 17/639,808

(22) PCT Filed: Sep. 6, 2019
(86) PCT No.: PCT/IN2019/050642

§ 371 Date: Mar. 2, 2022

(51) Int. Cl. H04L 43/0811; H04L 69/40; H04W 4/02; H04W 4/70; H04L 43/16; H04W 4/38

(52) U.S. Cl. CPC H04L 43/0811; H04L 69/40; H04W 4/023; H04W 4/70; H04L 43/16; H04W 4/38

(57) ABSTRACT

The present disclosure relates to a method performed by a cloud node (104) for handling sensor nodes and fog nodes in a communications system (100), wherein the communications system comprises a plurality of sensor nodes (110) located at a plurality of locations, to be handled by the fog nodes (120), the method comprising obtaining (S300) a first number of sensor nodes and their respective locations, out of said plurality of sensor nodes, to monitor the communications system in its entirety, based on measurements from at least some of the plurality of sensor nodes at their respective locations; determining (S310) a second number of said fog nodes and their respective location, based on the first number of sensor nodes and a connectivity capacity of said second number of fog nodes, where the second number of fog nodes is determined to cover said first number of sensor nodes; ranking (S320) said second number of fog nodes according to a conditional probability of failure for the second number of fog nodes, based on determined information about the second number of fog nodes and their respective location; and identifying (S330) a top ranked subset of said second number of fog nodes, based on said ranking (S320) of said second number of fog nodes; and positioning (S340) a backup fog node at each location of the top ranked subset of the second number of fog nodes.

### TECHNICAL FIELD

The present invention relates to a method for positioning backup nodes in a network. In particular for placing backup nodes for fog networking.

### BACKGROUND

Next generation Fog networking not only envision enhancing the traditional communication use case, but also aim to meet the requirements of new use cases. Such new use cases include the smart automation (production and Factory), intelligent transport systems, smart grids, professional audio and mission critical UAV's. Many of the new use cases are focused on latency critical IoT applications and there is a need to analyze the requirements.

Fog computing or fog networking, also known as fogging, is pushing frontiers of computing applications, data, and services away from centralized cloud to the logical stream of the network edge. Fog networking system applies control, configuration, and management over the Internet backbone rather than the conventional solutions of primarily control by network gateways and switches, which are embedded within the communication network. Fog computing framework can be described as a highly virtualized computing infrastructure which provides hierarchical computing facilities with the help of edge server nodes. These fog nodes can be involved in wide applications and services to store and process the contents in close proximity of end users. In a telecom or wireless network scenario, fog applications might generate some real-time radio and network information that can offer a better analyzed experience to the user.

Due to the presence of Fog nodes in some critical applications, it will enable doing a setup for backup of few of the nodes, which is considered to be an industrial standard. To enable mission critical IoT applications, it requires extra care in the backup design of resources. One way is setting up better Cyber Physical Systems (CPS) for the communication infrastructure and networking.

A problem in such networks, is considering the requirement of backup for all the important fog nodes, which will generally increase the overhead and lead into a latency issues, e.g. in 5G communication services. Hence, the present disclosure discusses the node backup challenges and proposes solutions for the Fog environment and its framework to fulfill the requirements, which mainly benefit from latency, criticality and service-centric approaches.

Internet of Things (IoT) represents a vision in which the Internet as an open global platform that will extend into the physical realm by embedding sensors and actuators into physical objects such as appliances, machines, medical devices, and vehicles, and letting them communicate, compute and coordinate to enable a wide range of innovative applications and services. A customized design for IoT applications for Fog Random Access Network (one type of Fog node) requires heterogeneous communication, real-time computation, local storage and application specific functionalities. The benefits are expected to be reduced latency, increase throughput, leverage and locality and finally relieving backhaul load. 5G is envisioned to support unprecedented diverse applications and services with extremely heterogeneous performance requirements, i.e., mission critical IoT communication, massive machine-type communication and Big data management in mobile connectivity. In the 5G communication era, a new business models are expected to be introduced in Telecom operators circle. The operators will collaborate with application/service provider to provide better quality of IoT services, by providing backup for few latency mission critical applications. This may be performed by adding more and more backup nodes for IoT networking and for 5G applications, but this will create a lot of maintenance issues in the future. One of the most interesting problems is to analyze and explore the networking to find the redundant backup services, and remove the redundancy to improve the provision. The requirements of fog nodes in latency critical 5G applications will be substantiated below.

Digital innovation from the Internet of Things (IoT), Artificial Intelligence, Virtual Reality, Tactile Internet and 5G applications is creating a new paradigm for the society to work, commute, shop, assisted living and play in very fast and optimal way. 5G is the foundation for the digitalization of industries and society. Data from newly-connected industrial IOT scenarios are expected to increase from 1.1 zettabytes (or 89 exabytes) per year in 2016 to 2.3 zettabytes (or 194 exabytes) per year by 2020. Current “cloud-only” architectures cannot keep up with the volume and velocity of this data across the network, thereby reducing the value that can be created and captured from these investments. Together, the proliferation of cloud and IoT technologies enables small-scale and large-scale smart environments and systems for various domains, such as smart healthcare, smart cities, smart energy grids, or smart factories and automation vehicles. However, from a technological point of view, the decentralized nature of the IoT does not match the rather centralized structure of the cloud. Today, IoT data are mostly produced in a distributed way, sent to a centralized cloud for processing, and then delivered to the distributed stakeholders or other distributed IoT devices, often located close to the initial data sources. This centralized processing approach results in high communication delays and low data transfer rates between IoT devices as well as the IoT devices and potential users. Hence, the promotion of Fog nodes in between cloud and IoT sensors will enhance the value and achieve expected reach in mission critical 5G applications.

Fog node is the collection of devices capable of intelligently handle any situation by performing edge computing. Since multiple devices are involved, it is a complex task to find the needed backup fog nodes in any smart application. The concept of placing Fog nodes in an industrial scenario is different, with WiFi routers and sensors, where only signal strength between two objects is measured. But, we also have to measure various relevant correlated parameters of the connected devices present in a fog node. Moreover, in the fog networking scenario, the inherent characteristics like a) Low latency and location awareness; b) Wide-spread geographical distribution; c) Mobility; d) Very large number of nodes in close proximity, e) Predominant role of wireless access, f) Strong presence of streaming and real time applications, g) Heterogeneity will complicate the challenges of finding the requirement of backup fog nodes needed to accommodate the network and also to apply the minimization process on the fog nodes, since some of them are acting independently. So the existing algorithms will not applicable directly in finding minimal backup Fog nodes in any allotted area. We will also discuss the adaptability of changes needed in Fog environment relate to our problem statement.

Fog computing provides the ability to create device-to-device communications paths without disrupting existing edge-to-cloud communications. Data stored in fog nodes can also be uploaded to the appropriate cloud or to multiple clouds to bridge silos. Fog computing provides the missing link in the cloud-to-thing continuum. Fog architectures selectively move compute, storage, communication, control, and decision making closer to the network edge where data is being generated in order solve the limitations in current infrastructure to enable mission-critical, latency-critical, data-dense use cases.

Thus, there is a need for an improved method for positioning backup nodes in a network.

### Objects of the Invention

An objective of embodiments of the present invention is to provide a solution which mitigates or solves the drawbacks described above.

### SUMMARY OF THE INVENTION

The above objective is achieved by the subject matter described herein. Further advantageous implementation forms of the invention are further defined herein.

According to a first aspect of the invention, the above mentioned and other objectives are achieved by a method performed by a cloud node for handling sensor nodes and fog nodes in a communications system, wherein the communications system comprises a plurality of sensor nodes located at a plurality of locations, to be handled by the fog nodes, the method comprising obtaining a first number of sensor nodes and their respective locations, out of said plurality of sensor nodes, to monitor the communications system in its entirety, based on measurements from at least some of the plurality of sensor nodes at their respective locations; determining a second number of said fog nodes and their respective location, based on the first number of sensor nodes and a connectivity capacity of said second number of fog nodes, where the second number of fog nodes is determined to cover said first number of sensor nodes; ranking said second number of fog nodes according to a conditional probability of failure for the second number of fog nodes, based on determined information about the second number of fog nodes and their respective location; and identifying a top ranked subset of said second number of fog nodes, based on said ranking of said second number of fog nodes; and positioning a backup fog node at each location of the top ranked subset of the second number of fog nodes.

In a first embodiment according to the first aspect, ranking of the second number of fog nodes comprises randomly dividing the second number of fog nodes into sets of two fog node clusters each, and calculating conditional probability of failure for a first fog node cluster of each of said set of two fog node clusters.

In a second embodiment according to the first aspect, ranking of the second number of fog nodes further comprises performing weighted averaging of said first fog node clusters, using the calculated conditional probability of failure for said first fog node clusters, as weighting factors, creating averaged fog node clusters.

In a third embodiment according to the first aspect, performing weighted averaging of said fog node clusters further comprises iteratively performing: calculating the conditional probability for failure for each, potentially averaged, fog node cluster, identifying the, potentially averaged, fog node cluster having the lowest conditional probability for failure and replacing said identified, potentially averaged, fog node cluster with the averaged fog node cluster that was last created.

In a fourth embodiment according to the first aspect, the method further comprises identifying the fog node cluster for which the conditional probability for failure is the highest, said fog node cluster comprising various proportions of the first number of fog nodes, and wherein ranking of the first number of fog nodes comprises ranking the first number of fog nodes according to their respective proportion in the cluster having the highest conditional probability for failure.

In a fifth embodiment according to the first aspect, identifying the top ranked subset of said first number of fog nodes, comprising identifying the top subset of respective proportion of the first number of fog nodes.

In a first embodiment according to the first aspect, obtaining a first number of sensor nodes and their respective locations, comprises obtaining a backup sensor node for each sensor node of a subset of the first number of the sensor nodes.

The advantages of the first aspect are enabling effective use in applications of 5G to optimally place fog RAN's which consists of many sensors and communication devices and it can be expected to implement in many indoor environments for different purposes. A further advantage is to reduce the latency in acquiring of the data to process it, which is most important factor in 5G applications. A further advantage is to build dynamism to the applications and also can handle the case of fog node/sensor node failure case. A further advantage is that the method is capable to be endeavored in existing fog network setup to rank the fog nodes so that preference can be given for them in future. A further advantage is that the method can be universally used for many smart mission critical use cases in future to avoid the latency in 5G applications.

According to a second aspect of the invention, the above mentioned and other objectives are achieved by a cloud node in a communications system, wherein the communications system comprises a plurality of sensor nodes located at a plurality of locations, to be handled by fog nodes, wherein the cloud node is adapted to obtain a first number, out of said plurality, of sensor nodes and their respective locations, to monitor the communications system in its entirety, based on measurements from at least some of the plurality of sensor nodes at, at least some of the plurality of locations; determine a second number of said fog nodes and their respective location, based on the first number of sensor nodes and on a connectivity capacity of said fog nodes, where the second number of fog nodes is determined to cover said first number of sensor nodes; rank said second number of fog nodes according to a conditional probability of failure for the second number of fog nodes, based on determined information about the second number of fog nodes and their respective location; and identify a top ranked subset of said second number of fog nodes, based on the ranked second number of fog nodes; and position a backup fog node at each location of the top ranked subset of the second number of fog nodes.

In a first embodiment according to the second aspect, the cloud node is further adapted to determine the second number of fog nodes to monitor said first number of sensor nodes, with the condition that the number of possible connections to sensor nodes is constrained to said connectivity capacity of said fog nodes.

In a second embodiment according to the second aspect, the cloud node is further adapted to randomly divide the second number of fog nodes into sets of two clusters each, and calculate conditional probability of failure for a first fog node cluster of each of said sets of two fog node clusters.

In a third embodiment according to the second aspect, the cloud node is further adapted to comprising weight average said first fog node clusters, using the calculated conditional probability for failure for said first fog node clusters, as weighting factors, and to create averaged fog node clusters.

In a fourth embodiment according to the second aspect, the cloud node is further adapted to iteratively perform: calculate the conditional probability for failure for the each, potentially averaged, fog node cluster, identify the, potentially averaged, fog node cluster having the lowest conditional probability for failure and replace said identified, potentially averaged, fog node cluster with the averaged fog node cluster that was last created.

In a fifth embodiment according to the second aspect, the cloud node is further adapted to identify the fog node cluster for which the conditional probability for failure is the highest, said for node cluster comprising various proportions of the first number of fog nodes, and to rank the first number of fog nodes according to their respective proportion in the fro node cluster having the highest conditional probability for failure.

In a sixth embodiment according to the second aspect, the cloud node is further adapted to identify the top subset of respective proportion of the first number of fog nodes.

In a seventh embodiment according to the second aspect, the cloud node is further adapted to obtain a backup sensor node for each sensor node of a subset of the first number of the sensor nodes.

According to a third aspect of the invention, the above mentioned and other objectives are achieved by a computer program comprising instructions which, when executed on at least one processor, cause the at least one processor to carry out the method according to the first aspect.

According to a fourth aspect of the invention, the above mentioned and other objectives are achieved by a carrier comprising the computer program according to the third aspect, wherein the carrier is one of an electronic signal, optical signal, radio signal or computer readable storage medium.

The advantages of the second to fourth aspect are at least the same as for the first aspect.

It is noted that embodiments of the present disclosure relate to all possible combinations of features recited in the claims. The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 shows a diagram illustrating probability of failure versus the rate of nodes provided with backup nodes.

FIG. 2 shows a block diagram of a first step of the method according to one or more embodiments of the present disclosure.

FIG. 3 shows a block diagram of the proposed method for ranking of the nodes according to one or more embodiments of the present disclosure.

FIG. 4 shows yet a diagram illustrating probability of failure versus the rate of nodes provided with backup nodes.

FIG. 5 shows yet a diagram illustrating probability of failure versus a number of iterations.

FIG. 6 shows a block diagram of the proposed method according to one or more embodiments of the present disclosure.

FIG. 7 shows an example of a network, in the form of a wireless network QQ106, in accordance with some embodiments of the present disclosure.

FIG. 8 shows details of a node in the form of a network node QQ160 according to one or more embodiments.

FIG. 9 shows details of a node in the form of a wireless device QQ110 according to one or more embodiments.

A more complete understanding of embodiments of the invention will be afforded to those skilled in the art, as well as a realization of additional advantages thereof, by a consideration of the following detailed description of one or more embodiments. It should be appreciated that like reference numerals are used to identify like elements illustrated in one or more of the figures.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

New radio (NR) is the radio interface for fifth generation of wireless networks (5g). NR design is based on a flexible structure where any time domain resource for transmission can be allocated for DownLink (DL) or UpLink (UL) or a combination of both. If the DL and UL transmission occur on different carriers, it resembles Frequency Division Duplex (FDD) type of operation in e.g. LTE. However, if UL and DL transmissions occur on the same carrier it resembles Time Division Duplex (TDD) type of operation in LTE. Due to the built-in flexible design in NR, the NR operation is sometimes referred to as Dynamic TDD operation. This enables NR to maximally utilize available radio resources in the most efficient way for both traffic directions, e.g. UL and DL. The traditional LTE technology only supports static TDD where time domain resources are split between downlink and uplink based on a long-term configuration. This can be very inefficient, particularly when only one traffic direction exists since the other dedicated time resource for the other direction is wasted.

In this disclosure, the term “wireless network node” may refer to a base station or radio node. This is a more general term and can correspond to any type of radio network node or any network node, which communicates with a UE and/or with another network node. Examples of network nodes are NodeB, base station (BS), multi-standard radio (MSR) radio node such as MSR BS, eNodeB, gNodeB. MeNB, SeNB, network controller, radio network controller (RNC), base station controller (BSC), road side unit (RSU), relay, donor node controlling relay, base transceiver station (BTS), access point (AP), transmission points, transmission nodes, RRU, RRH, nodes in distributed antenna system (DAS), core network node (e.g. MSC, MME etc), O&M, OSS, SON, positioning node (e.g. E-SMLC) etc.

In this disclosure, the term “radio access technology” used herein, or RAT, may refer to any RAT e.g. UTRA, E-UTRA, narrow band internet of things (NB-IoT), WiFi, Bluetooth, next generation RAT (NR), 4G, 5G, etc. Any of the first and the second nodes may be capable of supporting a single or multiple RATs.

In this disclosure, the term “cloud node” may refer to node comprising huge computation resources and data communication capability, e.g. an centralized server, data center etc.

In this disclosure, the term “sensor nodes” used herein may refer to nodes comprising measurement capability and data communication capability, e.g. an Internet Of Things, IoT, sensor, such as a temperature sensor, a wind direction sensor, a relative humidity sensor, a wind speed sensor, a global radiation sensor, a pressure sensors or a net radiation sensor

In this disclosure, the term “fog node” used herein may refer to nodes involved in fog computing or fog networking, also known as fogging. Fog computing may be a network architecture that uses edge devices, e.g. to carry out a substantial amount of computation and/or storage and/or communication locally, and is typically routed over the internet backbone.

In this disclosure, the term “conditional probability of failure” refers to a probability of failure for a particular cluster of network nodes, when a particular combination of nodes form a particular cluster. For example, assume the devices 1 and devices 2 are connected in serial fashion. Then, the probability of failure of devices 2 when device 1 failed is 0.

The present disclosure relates to the challenge of positioning and/or assigning of backup fog nodes in a network, e.g. a wireless network, typically used for mission critical applications. In general, for mission critical applications, there will always be a backup node positioned or co-located for each node, e.g. a backup fog node positioned for each existing fog node. Adding backup nodes for all nodes in the environment/network will increase the cost and latency. To avoid this, the present disclosure, discloses an idea of distinguishing between critical fog nodes and non-critical fog nodes, and further to remove backup nodes for the non-critical fog nodes. This makes the system latency-aware, which is most important factor for 5G communication systems.

The present disclosure uses boosted clustering methodology to identify critical node and non-critical node clusters. With the use of newly proposed node ranking algorithm, the disclosure proposes to identify the top most critical nodes in the network, and add backup only for those nodes which are identified as critical and, if needed, remove the redundant backup nodes with other nodes in the network. The disclosure proposes to achieve this by calculating a conditional probability of failure for each cluster, and the concerned nodes. Using the conditional probability of failures, the disclosure proposes to identify critical fog nodes as the top N ranked nodes. Hence, the top N ranked nodes are only allowed to keep their positioned or assigned backup node. Any backup node positioned or assigned to a node not included in the top N ranked nodes, are removed to create latency-aware Fog networking for 5G communication systems.

The detailed technical specifications for ITU's IMT standards are developed in close collaboration with the leading national, regional and international radio standards development organizations and partnerships towards the enhancement of Mobile broadband IMT requirements and the mission critical applications are in the main driver seat for the enhancement of mobile broadband for 5G relevant implementations. Use cases foreseen include enhancement of the traditional mobile broadband scenarios as well as ultra-reliable and low latency communications and massive machine-type communications. IMT-2020 will be a cornerstone for all of the activities related to attaining the goals in the 2030 Agenda for Sustainable Development. In the above mission critical applications, one has to assume all sensor and fog nodes are working continuously without any interruption. However, in practice this is not the case as failures can happen. In this case, one needs to think of placing redundant sensors/fog nodes as back up. As per the manual in, one need to install backup sensor node and backup fog node for each sensor and fog node installed. As an example, if you need to place 10 fog nodes in a given location, we need to place/install 10 more fog nodes as backup. In this case, the total number of fog nodes and relevant sensors to be installed is 20 in number. In literature, one can find some works on reducing number of backup sensors. However, they are restricted only to sensor nodes. However, the case of fog environment is entirely different from the current perspective.

The fog nodes have different characteristics as they share also computation among sensor nodes. If the fog node fails, it effects the computation of the node also should bear by neighboring nodes. Hence, to ensure proper redundancy we need to install fog nodes with all sensor nodes as backup. However, this is not economically feasible as it involves too much cost and introduces latency critical issues in future 5G communication.

Hence, in this disclosure, we provide a solution to install a minimum number of fog nodes and remove any redundant nodes (which is filed already). Further, to install backup fog nodes, we propose a method to identify important fog nodes (critical to be specific) and keeping backup nodes ready only for them. This is similar to critical node identification in graph theory. In any critical node identification, the knowledge of the network should be known prior to estimation. In addition, the computation of such method depends on number of nodes in the network. However, in this case i.e. of fog networks the entire network is dynamic and important fog node changes every time. Also, the number of nodes in the network always changes with time (always increase and decrease). Hence, in this disclosure, we propose an approach which is computationally efficient and also does not require the knowledge of the network.

Need of change in Fog Computing Framework for 5G Networking

The main idea of utilizing cellular infrastructure for fog computing, is that it explores the use of hierarchical architecture. Many research studies recently, explored cellular infrastructure especially 5G networks that is LTE-A for developing Fog computing in different applications. One of the primary use of LTE-A network for high speed communication purpose is for the signal processing activities through Fog Radio Access Networks. A RAN architecture for 5G systems based on Fog computing is an effective extension of cloud based RAN. It is used to reduce the front haul load and delay with the help of using virtualized baseband processing units. The edge processing and virtualization are the most efficient aspects in the context of 5G networks. Recently fog based catching at the edge devices in radio access network has been explored and it used to identify the optimal catching along with front haul and edge transmission policies. Moreover, 5G systems need more latency-sensitivity than the 4G systems. Fog computing is being applied in 5G systems to minimize the delay which includes communication and computing delay. Another issue to be addressed in using Fog computing for 5G applications is the load balancing. It is able to provide low latency interactions between machine to machine communications. Hence it can be noted that the 5G based cellular system and the fog computing framework are very much related to each other in terms of compatibility compare to cloud computing. In this disclosure, we have proposed new

Fog computing method to reinforce the environment by reducing the redundant backup nodes and keep only required very minimal backup Fog nodes for latency critical 5G applications.

In the text below, it is assumed that an existing environment exists, with all sensor nodes and fog nodes functioning. However, as per industry standards, it is required to install additional back up nodes for every sensor/fog node installed. Having backup for all the nodes is not economical and maintenance also will be quite high. Hence, in this example network, we propose to identify critical fog nodes and sensor nodes and keep backup only for those critical fog nodes in the fog networking. But, finding those critical nodes are challenging in Fog networking and hence the existing algorithms will not to be applied here due to the inherent characteristics of Fog nodes.

The present disclosure proposes a node ranking algorithm, to identify critical fog/sensor nodes in the network.

First the disclosure explains the proposed node ranking algorithm, which is applied in fog networking to rank the combination of N fog nodes. Next, the disclosure explains the procedure to choose the value of N (a minimal number of backup nodes) through ad hoc approach, which may be used for selecting user-defined parameter in the algorithm. Finally, the disclosure explains the procedure of finding critical backup fog nodes.

### Node Ranking Algorithm

The proposed algorithm can be broadly bescribed by 3 method steps:
Step 1. This step has two sub-parts, where the first part is a randomization step or involvement of the selection of initial clusters (5.1.1) and the second is a probability calculation step to obtain conditional probability of failure for each combination of nodes (5.1.2).
Step 2. A weight averaging step for formation of new combination (5.1.3).
Step 3. A top N nodes step for evaluating a convergence criterion (5.1.4).

### Selection of Initial Clusters, Randomization Step 5.1.1

Let a set of nodes be S of length M representing the total number of nodes involved in fog networking. The set S is divided into two clusters (i) A cluster C which contains the nodes where they are assumed to be critical and (ii) Another cluster \tilde{C} which contains the nodes that are assumed to be non-critical. The number of nodes in cluster C is fixed as N and \tilde{C} has M-N locations. Here it should be noted that C∪\tilde{C}=S and C∩\tilde{C}=Ø. Traditional methods for clustering cannot be employed here as there is no guarantee that N points can be obtained in a single cluster. Hence, in this work, hierarchical clustering (nested K-means), one form of boosted clustering methodology is employed, wherein the idea is to add each location to the cluster one by one based on a predefined criteria. In this work, the criterion for the selection of next location in C is based on the proximity to the previously selected node (in terms of the discrete value fo the node). The Mahalanobis distance measure is chosen to cluster the dataset because it can address noise in the data in terms of the weights. The metrics can be adapted to this proposed method as explained below

min ∥(cᵢ−cᵢ₊₁)∥ₚ (1)

where i varies from 1,2, . . . , N−1, c represents each element in set C and p varies depending on the distance metric chosen. Subsequently, P random sets of C and \tilde{C} are generated using the same ideology each with different metrics i.e. different values of p.

In addition, if any prior information is available on the critical node i.e a node is said to be critical, then it is possible to employ constrained clustering with a constraint as a location should be present in the set C. By this way, the proposed algorithm can be more generic and can be applied to more complex case studies.

Subsequently, construct a vector for each of the P combinations with 1 corresponding to the elements of C, where sensor is available and 0 corresponding to the elements of \tilde{C}, where node is assumed to be critical or not. Let the vectors constructed be k₁,k₂, . . . , k_{P}, where kᵢ=cᵢ∪\tilde{c}ᵢ, where cᵢ, \tilde{c}ᵢ are the elements taken from sets C and \tilde{C} respectively. At the end of the current step, one obtain data divided into P combinations of two clusters. Next, for each combination we need to compute failure for each of the cluster. The computation of the conditional probability for failure is explained in next section.

### Obtaining Probability of Failure of Clusters, Probability Calculation Step 5.1.2

As explained before, the main challenge of the work is in calculation of conditional probability of failure of a cluster assuming that another cluster fails. This is done using the procedure below. For ease of understanding, the disclosure assumes that the failure cluster is C₁ and other cluster is C₂.
1. First, we assume all the nodes in the cluster C₁ i.e. status is of zero. In this case, the failure distribution is assumed to be uniform.
2. Next, we calculate conditional probability of failure for all the nodes in the cluster C₂ in the cluster assuming first step.
3. Average out all the computed conditional probabilities of failures to calculate the overall conditional probability.

At the end of this step, we obtain conditional probability of failure for each combination.

### Formation of New Combination of Clusters, Weighted Averaging Step 5.1.3

From the step 1 of the proposed method, one obtain P vectors kᵢ,k₂, . . . , k_{P} corresponding to critical nodes and from step 2, one obtain P probability values I₁,I₂, . . . , I_{P}. For next combination, we obtain another new vector k_{P+1} is obtained as weighted average of all the P combinations as

k_{P+1}=I₁k₁+I₂k₂+ . . . I_{P}k_{P} (2)

For the obtained combination k_{P+1}, the failure probability is calculated using the method explained in step 2. Let the obtained value be I_{P+1}. Subsequently, out of these P combinations i.e. k₁,k₂, . . . , k_{P}, the combination which has the lowest probability of failure is replaced with the new obtained combination k_{P+1}. The reason is explained as follows.

Here we are calculating the conditional probability of failures. In this way, we are calculating P combinations. For each combination, we calculate probability of failures. High number of node failure ensures high failure rate, which infers the nodes in the cluster are critical when another cluster of nodes fails. Hence, we replace the new combination of cluster (highest probability) with the combination having lowest probability of failures.

Once we obtain new combination and replaced with the old combination, we obtain new set of P combinations. Further, we compute new weighted average of these P combinations to obtain new combination. This process is repeated until convergence condition which is discussed in next section.

### Convergence Criterion

This process is repeated until |I_{P+i}−I_{P+i-1}|≤ϵ for any i. This implies that there is no possibility for increase in probability by the formation of new clusters. After convergence, the obtained values are arranged in descending order and the indices gives the rankings of the node based on the averaged conditional probability of the nodes.

### Top N Nodes Step 5.1.4

Finally, the top N indices are extracted. These N indices correspond to N critical nodes, which is the objective of the proposed algorithm. Please note that these N values correspond to elements in C and remaining elements in \tilde{C} for the converged combination.

It should be noted that the choice of ϵ depends on the application. Higher value of the ϵ corresponds to more time for convergence and lower value of ϵ results in poor performance of the method resulting in high error. For the less critical applications or the network has multiple number of nodes, we choose to employ larger ϵ, where as critical applications or smaller networks we choose to employ smaller ϵ.

In the overall algorithm, computation of the conditional probability of failure will be taken most of the time as the weighted average and cluster formation will take minimal time. One should also remember that employing Bayesian networking criterion (like bayesian estimator) may result in the convergence to local optima which can result in mismatch between the original distribution and obtained distribution. However, the aim of the work is to identify the critical nodes which works on taking expectation (average in time sense) of all the individual conditional probabilities of failures, this problem can be easily nullified.

As discussed, the proposed method will give the user the top N combination of critical nodes in the network. However, the user has to mention the value of N as it can influence the proposed method. In next section, we discuss an ad hoc procedure to select the value of N along with few guidelines.

### Identification of Number of Critical Nodes:

The choice of N value can impact the accuracy of the proposed method. Higher the value of N means there are higher number of critical nodes in the network and it means we need to spend more cost to install backup nodes. In other case, lower value of N can result in lower number of critical nodes which introduces two different problems (i) May be there are more number of critical nodes in the network which one would have missed or (ii) can result in higher error since, the probability of failure of the network will be higher as all critical nodes are not captured. Hence, in this work, we suggest the user to select value of N by employing an ad hoc approach.

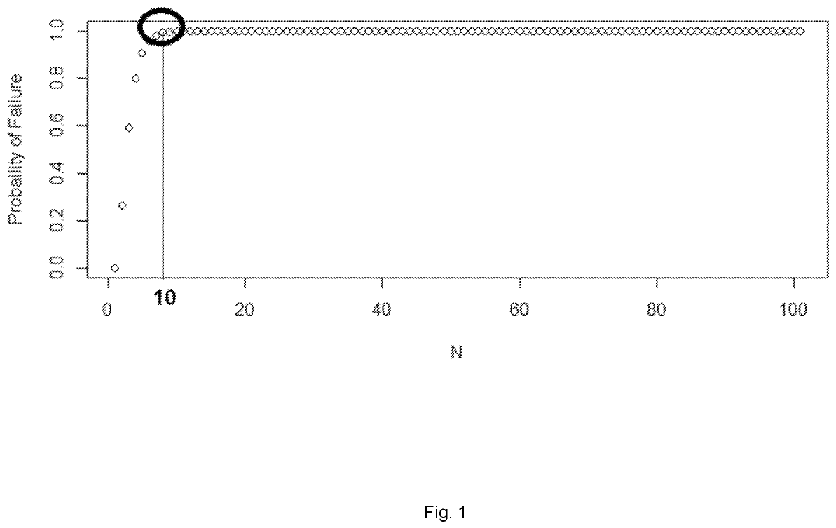

FIG. 1 shows a diagram illustrating probability of failure versus the rate of nodes provided with backup nodes. In one example, we run the proposed method for different values of N ranging from 1 to M (number of nodes in the network). For every N, we obtain the probability value as explained above, at the convergence, let us assume it as I. Next, we plot the values of I vs different values of N. The graph may look like something like the graph illustrated in FIG. 1.

From the plot in FIG. 1, one can observe that, with increase in value of N, the probability increases. This is agreeable as the network can have at least greater than critical nodes in the network. As N increases, the probability also increases, it will settle to higher value (generally 1 or near equal to 1). Once it captures all the critical nodes in the network, the probability settles at 1, suggesting any addition of critical nodes does not change the probability which means there are no further critical nodes present the network. Hence, we suggest the user to choose the value of N where the probability value stopped increasing. In above example, the optimal value of N is 10.

As mentioned, this is an ad hoc approach for choosing the value of N. Next, the disclosure discusses the usage of the proposed method in identifying the critical fog nodes.

### Identification and Selection of Critical Fog Nodes:

Once the node ranking steps is done, the disclosure uses the following steps to compute the (most) important fog nodes.
1. First, use the proposed algorithm on the node ranking for all different types of sensor nodes.
2. Then, based on the ranking of the sensor nodes, identify and keep N back up nodes for each of the top N critical sensor nodes.

To explain this step a bit more, let us take an example of placing temperature (T) and pressure (P) sensors in the network.

| | | |
|---|---|---|
| T, P | | T |
| | T, P | P |
| | | T |

After this, the disclosure uses the node ranking algorithm to rank the nodes. It should be remembered that the node ranking is done for every different type of sensor. Assume the ranking of the nodes are obtained as shown below

| | | |
|---|---|---|
| T-1, P-3 | | T-2 |
| | T-4, P-1 | P-2 |
| | | T-3 |

In the table, the number given next to sensor type is the rank of the sensor node. Now, once, the rankings are obtained, we chose the top N nodes in each sensor type (the number may be different for different type of sensor). Then, we can place backup sensor for the identified top sensor nodes. For example, let us assume we chose the value of N as 2 for temperature and 1 for pressure. In this case, the backup sensor locations will be

| | | |
|---|---|---|
| T-1, P-3, T | | T-2, T |
| | T-4, P-1, P | P-2 |
| | | T-3 |

It should be noted that the critical sensors are shown as bold. Once, this is created, we solve the following reinforcing fogging problem to place minimum number of backup fog nodes.
3. Placement of fog nodes:

The following optimization problem may be defined to solve for the placement of fog nodes.

$$\begin{matrix}min \\ {a}_{j}\end{matrix} {\sum }_{j = 1}^{M} \vert {a}_{j} \vert subject to \{ {\sum }_{k = j - 1}^{j + 1} {\sum }_{p = j - 1}^{j + 1} {x}_{k} {x}_{p} < capacity of ( {a}_{j} ) , \\ ∀ j = 1 , … , M$$

where M is number of locations to be monitored and aⱼ is the locations where the fog nodes are to be placed. The objective function |aⱼ| ensures that the location of the fog node is sparse i.e. we obtain minimum number of fog nodes to be placed and the constrain Σₖ₌ⱼ₋₁^{j+1}Σₚ₌ⱼ₋₁^{j+1} xⱼ measures the number of sensors placed around the location aⱼ should be less than the capacity of the fog node which establishes load balancing more than expected level.

For example, let us assume there is fog node which can take utmost three sensors connection and range of the fog node is only 1 m which is same as the length of the grid in the location. In this case, the optimization problem can be written as

$$\begin{matrix}min \\ {a}_{j}\end{matrix} {\sum }_{j = 1}^{16} \vert {a}_{j} \vert subject to \{ {\sum }_{k = j - 1}^{j + 1} {\sum }_{p = j - 1}^{j + 1} {x}_{k} {x}_{p} \leq 3 , \\ ∀ j = 1 , … , 16.$$

In this case, we solve the optimization problem with sum of both installed nodes as well as backup nodes. Truly speaking, we should not consider the backup sensor nodes here as they will come into effect only when the sensor nodes are failed. However, there are some chances that these nodes may come into action even before the sensor node fails i.e. predicts to fail in next some time. To ensure proper handover, there are sometimes the sensor and backup sensor need to work together. In general, fog nodes with additional one more backup nodes are used to monitor both sensor nodes. This creates the redundancy in the network w.r.t sensors and one can obtain the optimal placement of fog nodes. Assume, the algorithm returned result something like this.

| | | | |
|---|---|---|---|
| T-1, P-3, T | | F | T-2, T |
| F | F | | |
| | T-4, P-1, P | | P-2 |
| | | F | T-3 |

From the table, it is evident that the algorithm returned four fog nodes required to monitor the network.
backup Fog nodes: The proposed algorithm is used to rank the fog nodes in the network. Assume the fog nodes ranking are obtained below

| | | | |
|---|---|---|---|
| T-1, P-3, T | | F-4 | T-2, T |
| F-1 | F-3 | | |
| | T-4, P-1, P | | P-2 |
| | | F-2 | T-3 |

From the table, we can compute the backup fog nodes as below. For this also, we chose a top N number for fog nodes are selected and we kept other fog nodes backup for N fog nodes selected. In this way, we can come with the placement of the fog nodes along with backup fog nodes. In this case, the backup fog nodes are selected as (assuming N value is 2)

| | | | |
|---|---|---|---|
| T-1, P-3, T | | F-4 | T-2, T |
| F-1, F | F-3 | | |
| | T-4, P-1, P | | P-2 |
| | | F-2, F | T-3 |

At the end of this step, we compute the optimal placement of fog nodes along with their positions along with the backup fog nodes information also.

At the end of the current step, we can obtain the critical fog nodes and their optimal locations. As mentioned in the algorithm, the proposed method contains some user defined parameters. For each sensor type, the user need to specify how many extra sensors need backup so that many top critical sensors nodes are chosen. However, this requires some knowledge on the process and also it depends on the cost of maintenance. In this work, we assume the number is known to the user for better simplicity. However, it is easy to extend the work on finding number of critical sensors and this number can be obtained by solving an optimization problem. The same discussion can be extended to the choice of critical fog node identification.

As discussed above, the proposed method identifies critical fog nodes and identifies backup fog nodes for better operation. Under normal conditions i.e. without any backup fog nodes, already we installed minimum number of fog nodes to monitor the network. If any fog node fails, then it can result in too much business loss for the company. For example, in the application of load balancing, the fog nodes ensure low latency interactions between machine to machine communications. In the case of fog node failure, there are some algorithms which ensure another near fog node take care of this fog node computation. However, this can increase the latency of the work and results in missing of important data. Another problem is that nearby fog node should contain same resources of failure fog node. This is not easy task and hence, in this proposed method we chose to keep backup for these fog nodes. In addition, we are not keeping backup for every fog node, since this can result in higher costs. Hence, we chose to rank the fog nodes and keep only backup fog nodes for top identified critical fog nodes. For the non-critical fog nodes, there is no need of keeping backup as their failure does not result in too much loss for the company. This can save lots of money for the company as only subset of redundant sensor/fog nodes are used for backup. This can reduce the latency which is a critical requirement for 5G communication services.

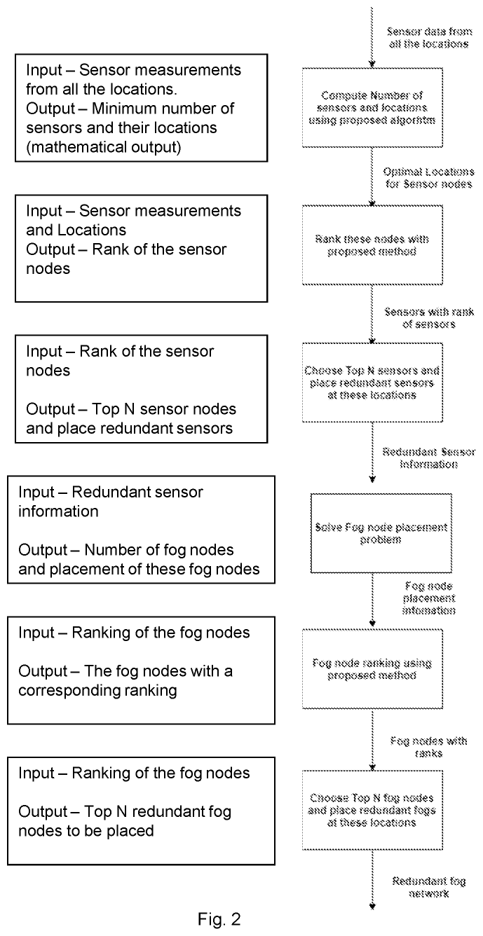

FIG. 2 shows a block diagram of a proposed method according to one or more embodiments of the present disclosure.

In a first step represented by a first block in the figure, a first number of sensors nodes or nodes to monitor the communications system in its entirety and the corresponding locations are calculated or computed using the method described herein. The input data comprises input sensor measurements from all the locations hosing a node. The output data comprises a second minimum number of sensors or nodes, their identity and their locations, i.e. a mathematical output. In other words optimal locations for sensor nodes or backup fog nodes.

In a second step represented by a second block in the figure, the second minimum number of sensors or nodes, as further described below. The input data is the second minimum number of sensors or nodes, their identity and their locations. The output data is a ranked list of the second minimum number of sensors or nodes, their identity and their locations. In other words, a list of sensors with a corresponding ranking of the sensors.

In a third step represented by a third block in the figure, the top number N of ranked sensors are selected or chosen, and redundant sensors are placed at locations of the top number N of ranked sensors. The input data is the list of sensors with a corresponding ranking of the sensors. The output data is a list of the top number N of ranked sensors and the placement or location of the redundant sensors.

In a fourth step represented by a fourth block in the figure, the fog node placement problem is solved. This problem may e.g. bee solved by solving an optimization problem, as further described herein. The input data is the list of the top number N of ranked sensors and the placement or location of the redundant sensors. The output data is placement or location of the fog nodes.

In a fifth step represented by a fifth block in the figure, the fog nodes are ranked using the methods described herein. The input data is the placement or location of the fog nodes. The output data is a ranked list of the fog nodes, their identity and their locations. In other words, a list of fog nodes with a corresponding ranking.

In a sixth step represented by a sixth block in the figure, a top number N of ranked fog nodes are selected or chosen, and placed at the corresponding locations. The input data is the ranked list of the fog nodes. The output data is the top number N of ranked fog nodes, and their location. The top number N of ranked fog nodes are placed at their corresponding location, this a redundant fog network is formed.

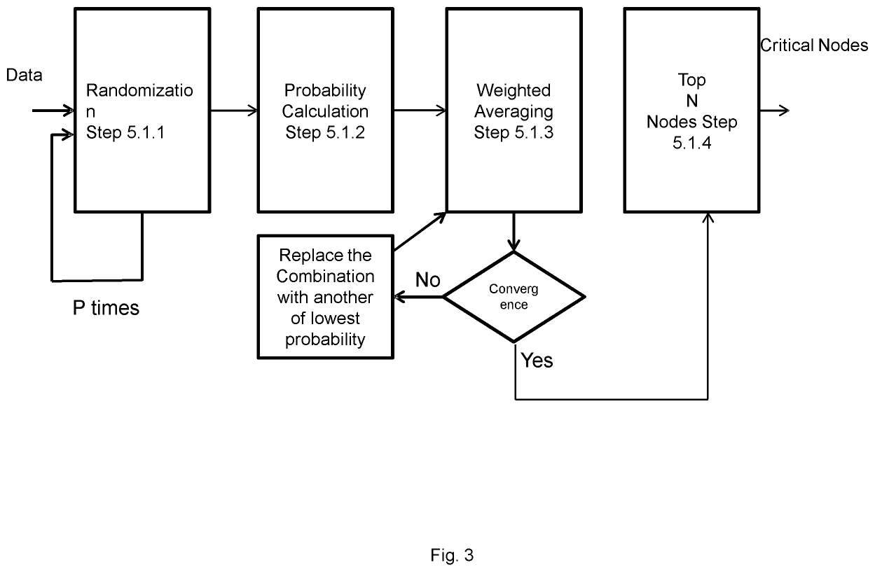

FIG. 3 shows a block diagram of the proposed method for ranking of the nodes according to one or more embodiments of the present disclosure. As can be seen from the figure, the method involves a randomization step 5.1.1, that may be repeated a number P times. Further the method comprises a probability calculation step 5.1.3. Further the method comprises a weighted averaging step 5.1.3.

After the weighted averaging step, it is checked if convergence has been achieved.

If convergence has been achieved, the method proceeds with a top number N nodes step 5.1.4. Alternatively, if convergence has not been achieved, the method proceeds with replace the current combination with another combination of lowest probability, and returning to the weighted averaging step.

Details of the various steps of the method, is further described above in relation to the section detailing the node ranking algorithm.

In this work, the fog coverage area is assumed and pass as input to the proposed method. By this, it can be ensured that the fog nodes can result in low-latency as the distance to transfer the information is less and it can result in low-latency applications.

Hence we have discussed in this Disclosure that our method can able to explore the basic requirements (like avoid delay, Fog catching and low latency) to establish fog computing (especially Fog RAN usage) for any future 5G communication.

Next, we illustrate the proposed invention with the use of three case studies. In first case study, we explain the algorithm by the way of sample example chosen. In next case study, we used graph stream software to generate synthetic data to understand the performance of the proposed method. In final case study, we use a real time smart city dataset to explain the proposed approach.

### EXAMPLE 1

### Synthetic Dataset

To understand the essence of the proposed algorithm, let us assume we have M=10 sensors and we need to install for N (the choice of N is explained later) critical sensors and the backup sensors. As of now, assume the value of N as 3. The objective here is to select the best subset of size N of the set {1,2,3,4,5,6,7,8,9,10} such that the subset has highest probability.
1. As explained earlier, a nested K-means clustering is run on the data to obtain two clusters of size 3 and 7 which corresponds to locations where the sensor is available and another not available. As an example we obtain two clusters as {1,3,5} and {2,4,6,7,8,9,10}. This implies that the nodes 1,3,5 are identified as critical nodes where the remaining nodes are not critical.
2. Subsequently, different combinations as obtained in the previous step are obtained using nested K-means clustering. Let us assume here for such two combinations are obtained and they are {{1,3,5},{2,4,6,7,8,9,10}} and {{1,2,4} and {3,5,6,7,8,9,10}}.
Further, a vector of length M corresponding to each combination is constructed with all zeros and ones where the location of zeros and ones depends on the location of the sensors. Suppose, let us take the first {{1,3,5},{2,4,6,7,8,9,10}}. Here we know the critical nodes are the nodes {1,3,5} and non-critical nodes are at locations {2,4,6,7,8,9,10}. In this case, the vector constructed will be

k₁=[1 0 1 0 1 0 0 0 0 0]^{T}
From the vector, one can observe the indices of 1 corresponds to critical nodes and zeros corresponds to non-critical nodes.
Similarly, for other combination {{1,2,4} and {3,5,6,7,8,9,10}}, we can construct vector as

k₂=[1 1 0 1 0 0 0 0 0 0]^{T}
3. Conditional Probability of failure calculation: Next step is to calculate Probability of failure for every combination of the critical nodes obtained in the previous step. Assume the probability of failure obtained for this combination is I₁. Similarly, for another combination we obtained the probability of failure is I₂.
4. Weighted averaging and iteration: Now, the vectors k₁ and k₂ are weighted averaged with the weights of the corresponding information as shown below

k₃=I₁k₁+I₂k₂
Let the obtained combination be k₃. Let the combination k₃ has the probability of failure I₃. After this, we substitute the new obtained combination k₃ in place of the two combinations {k₁, k₂} which have the lowest probability. For example, assume I₁<I₂. In this case, we replace the combination k₁ with the new obtained combination and repeat the iterative process until convergence.
5. Selection: Finally, let the vector obtained after convergence as p₁. After the indices of the top N=3 nodes in the vector p₁ gives us the critical nodes, which is the objective of the work. In our case, let the vector p₁ obtained as

$${p}_{1} = [ \begin{matrix}0.25 \\ 1.43 \\ 2.87 \\ 1.78 \\ 1.83 \\ 0 \\ 0 \\ 0 \\ 0 \\ 0\end{matrix} ]$$

In this case, top 3 locations correspond to indices {3,4,5}, suggests the critical nodes are {3,4,5}.

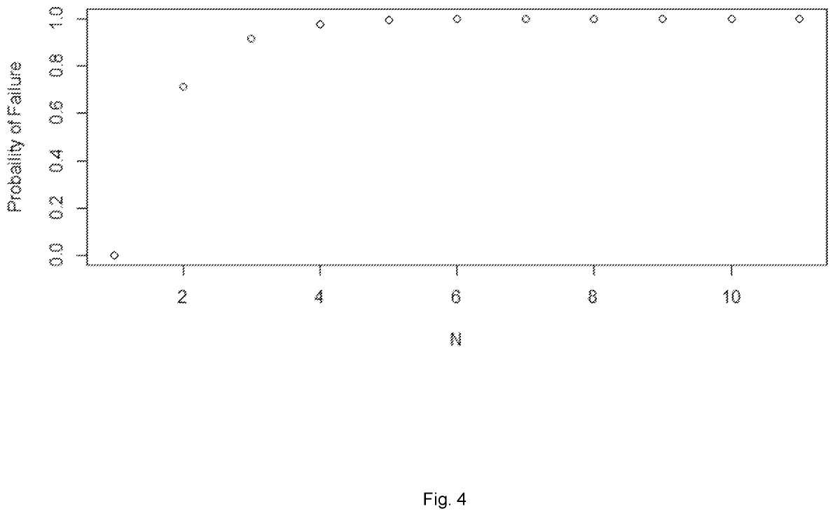

Once this is identified, we shift the focus to choose the value of N. For this, we run the ad hoc approach for different value of N and each time we compute the value of probability of failure. In this case, the graph obtained is shown in FIG. 4.

FIG. 4 shows yet a diagram illustrating probability of failure versus the rate of nodes provided with backup nodes.

In this case, one can observe the probability value stopped increasing once, the value of N crosses 3 suggesting there are only 3 critical nodes in the network. In this way, we choose the value of N as 3 for this case study. This illustration is only to understand how the problem works and mathematics behind it. Next, the disclosure uses a synthetic dataset to compare the performance of the proposed method with that of an existing method in literature.

### EXAMPLE 2

### Proposed Ranking Method

To test the proposed algorithm, synthetic data corresponding to the network is generated using the Graph Stream software. The proposed algorithm is used to rank the nodes and identify the critical nodes in the network. The rankings of the nodes obtained from the proposed algorithm are given in the table below:

| Node | Proposed Algorithm | Existing Algorithm |
|---|---|---|
| C | 1 | 1 |
| B | 2 | 3 |
| D | 3 | 2 |

The results obtained from the proposed algorithm matches with our discussion above, where the node C is identified as critical node. For comparison purpose, the critical nodes are also identified using the existing algorithm. It should be remembered that while using the existing algorithm it is assumed that the network is known before identification.

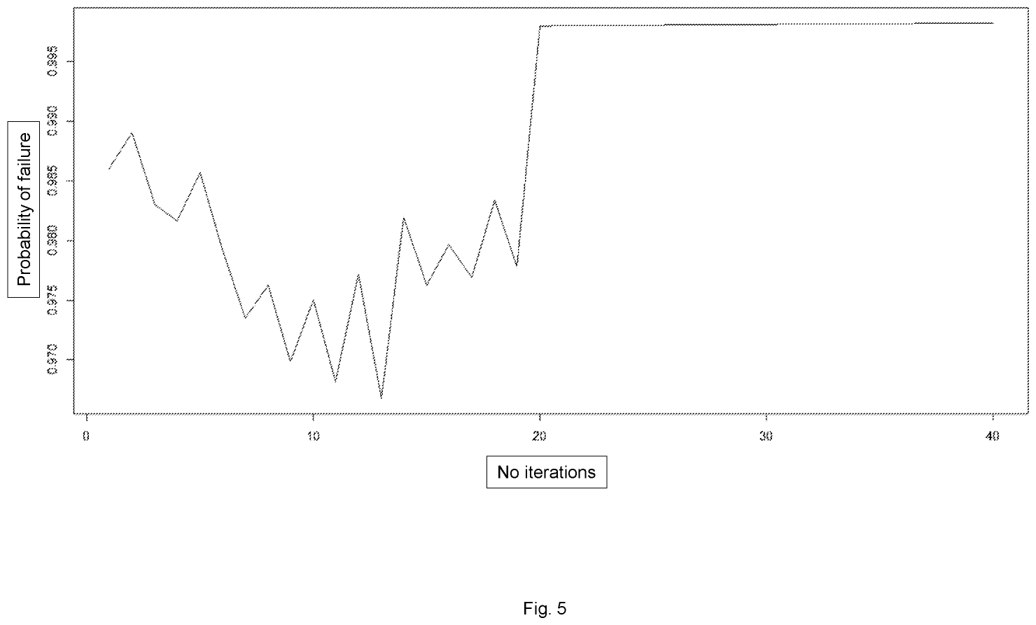

As remarked at the end of the previous section, the convergence of the proposed algorithm is shown using simulations. The plot of the variation of the probability of the failure of the network with the iterations is shown in FIG. 5.

FIG. 5 shows yet a diagram illustrating probability of failure versus a number of iterations.

From the plot, it is evident that the probability is monotonically increasing corresponding to the convergence of the proposed algorithm

### EXAMPLE 3

### Minimum Backup Fog Node Placement Without Redundancy in Smart City Environment

The data discussed here is real-time weather data of city Berlin. It consists of 8 different types of sensors placed across different locations. The different types of sensors are
Temperature
Wind Direction
Relative Humidity
Wind Speed
Global Radiation
Atmospheric Pressure
Net Radiation

These sensors are placed at different locations across the city. The dataset contains, 8 temperature sensor readings, 8 wind direction sensors readings, 6 relative humidity sensor readings, 5 wind speed sensor readings, 5 global radiation sensor readings, 3 pressure sensors readings and 3 net radiation sensor readings.

To use the proposed method, we divide the area to 3×3 grid which comprises of 9 locations. Each location corresponds to square box of 3 km×3 km. This is done because the maximum number of sensors of single type is 8. Further, we interpolate the information across this 3×3 grid for different types of sensors to generate data for all the locations.
Locations Used in Illustration

| | | |
|---|---|---|
| 1 | 2 | 3 |
| 4 | 5 | 6 |
| 7 | 8 | 9 |

Subsequently, we use the proposed method to optimally place the different types of sensors. First, we use the mathematical optimization to compute the number of sensors along with their locations. Subsequently, we verified this information using the graph based approach.

For every type of sensor, the optimal locations are obtained as

{‘Atmospheric Pressure’: array([4]),

‘Global Radiation’: array([8]),

‘Net Radiation’: array([8]),

‘Relative Humidity’: array([8, 4]),

‘Temperature’: array([4, 2, 6]),

‘Wind Direction’: array([4, 6, 3, 9]),

‘Wind Speed’: array([4, 3, 1, 2, 6])}

It should be noted that, we need different number of sensors for different types of sensors. Although, this is the output of the optimization problem, the result agrees with the physics of the process, as atmospheric pressure variation will be less, when compared with wind speed. Hence, for atmospheric pressure we need less number of sensors, whereas for wind speed we need more number of sensors.

Finally, we calculate the optimal locations to place fog using step-3 of the method. The solution the step-3 of the method returned is

| | | |
|---|---|---|
| WS | T, WS | WD, WS |
| AP, RH, T, WD, WS | | T, WD, WS |
| | GR, NR, RH, | WD |

We use the proposed method to rank these sensor nodes. In the case of this work, the rankings obtained are

| | | |
|---|---|---|
| WS-1 | T-1, WS-4 | WD-1, WS-2 |
| AP-1, RH-2, T-2, WD-2, WS-3 | | T-3, WD-4, WS-3 |
| | GR-1, NR-1, RH-1 | WD-3 |

Once these details are obtained we chose to place backup sensors for top 2 sensors of type (WS,WD,T) and one sensor for remaining type. The backup sensor information is given in the following table

| | | |
|---|---|---|
| WS, WS | T, WS, T | WD, WS, WD, WS |
| AP, RH, T, WD, | | T, WD, WS |
| WS, AP, WD, T, | | |
| | GR, NR, RH, RH, GR, NR, RH | WD |

After this, we use the node ranking method to obtain minimal number of backup fog nodes and their placement.

In deriving of the fog node locations, we must pass two input arguments. (i) maximum number of sensors to be communicated with a single fog node and (ii) maximum area of coverage of each fog node. In this example, we chosen the maximum number of sensors to be communicated with a single fog node is 5 and maximum coverage area is 6 KM i.e. a fog node can monitor the sensors located in neighboring grids. The obtained fog placement is shown in the table below

| | | |
|---|---|---|
| WS, WS, Fog 2 | T, WS, T | WD, WS, WD, WS |
| AP, RH, T, WD, | Fog 3 | T, WD, WS, Fog 5 |
| WS, AP, WD, T | | |
| Fog 1 | GR, NR, RH, RH, GR, NR, | WD |
| | RH, Fog 4 | |

The optimization problem resulted in a solution of 5 fog nodes with the locations of fog nodes as shown in the table. If you use the normal method, we require to place 7 fog nodes at these locations to monitor. However, it is shown that only 4 fog nodes are enough to monitor the entire locations with these sensors. This can be translated to huge savings of money as the maintenance costs associated with these fog nodes are high. For a big location, let's say of size of order of 100×1000, this can be translated to billion-dollar savings.

Now, coming to redundancy part, we rank the fog nodes in the table using the proposed method. The proposed method with the fog node rankings is given in the table

| | | |
|---|---|---|
| WS, WS, Fog 2-4 | T, WS, T | WD, WS, WD, WS |
| AP, RH, T, WD, WS, | Fog 3-5 | T, WD, WS, Fog 5-3 |
| AP, WD, T | | |
| Fog 1-1 | GR, NR, RH, RH, GR, | WD |
| | NR, RH, Fog 4-2 | |

Once the fog nodes ranks are identified, then as discussed we select top N (2 in this case), to install backup fog nodes. In this case we keep Fog1 and Fog 4 are the 2 fog nodes considered for backup. Backup is not required for the remaining 3 fog nodes as they are non-critical.

It should be remembered that the rankings of the fog nodes and sensor nodes are relative and will change whenever there is a change in network. For example, consider the scenario of the connected cars system, where number of sensor join the network and leave the network. In this case, the algorithm is run for every time interval (like per day) to obtain new set of fog nodes and sensor nodes and the respected rankings. In this case, the fog nodes positions are changed to change the position of backup fog nodes.

The present disclosure aims to provide mission critical communication with ultra-low latency, ultra-high reliability, availability, and security to fog nodes with CPS-aware in 5G by leveraging a node ranking method to address the identification of redundant backup fog nodes in Fog Networking. The proposed method may comprise three inherent steps:
(i) First, to run a new boosted-based clustering methodology to derive a required conditional probability in selecting best node clusters of sensor and fog nodes.
(ii) Apply Bayesian networking principle to represent and estimate the importance of backup sensor and fog nodes and select the best and most critical ones.
(iii) Finally, we identify the critical fog nodes (to install backup nodes) for establishing ultra-low latency in latency critical 5G applications since their failure cannot affect the network.

These three steps are repeated for every given time interval to estimate the important fog nodes and place only critical backup fog nodes. In this way, we can re-run the method to ensure always the presence of required number of backup fog nodes and eradicate the redundant nodes.

The disclosure assumes all the sensors and fog nodes are placed in given environment and the required (minimum) number of fog nodes are calculated with their placement. The proposed method is based on the ideas of boosted clustering methodology wherein the random clusters are averaged to obtain good clusters. In this work, conditional probability of the failure of the network is considered as the factor for ranking the nodes. By this way, we can identify critical nodes as these nodes are given top rank irrespective of the structure of the network.

The reason for choosing the clustering methodology is explained as follows. There are many nodes in the network and if task is performed in node level, the number of computations will increase. Hence, we alternatively perform the transactions on cluster level to compute the critical cluster of fog nodes to decrease the computation. Moreover, it helps to identify the set of nodes as critical nodes. Finally, we rank the nodes in the identified cluster using the same approach (considering each node as cluster) to rank the fog nodes.

From the top N nodes, where N is a user defined parameter in the proposed method, which are identified to keep the N fog nodes as backup for the selected environment. Further, the identified N nodes are repeatedly used for every specified time interval, to adjust the redundancy in the existing fog nodes. In addition, we suggested an ad hoc procedure to select the value for N.

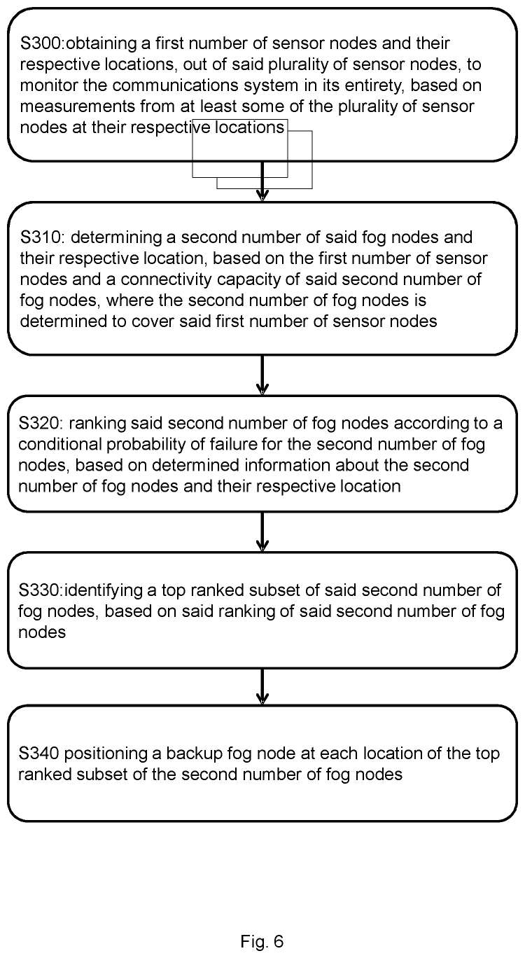

FIG. 6 shows a block diagram of the proposed method according to one or more embodiments of the present disclosure. A method performed by a cloud node 104 for handling sensor nodes and fog nodes in a communications system 100 is provided. The communications system comprises a plurality of sensor nodes 110 located at a plurality of locations, to be handled by the fog nodes 120. The method comprises:

S300: obtaining a first number of sensor nodes and their respective locations, out of said plurality of sensor nodes, to monitor the communications system in its entirety, based on measurements from at least some of the plurality of sensor nodes at their respective locations.

Existing sensor networks have all the sensors installed in a network. At a specified sampling time, these sensors transmit data to cloud for analyzing the status of the network. S310 determining a second number of said fog nodes and their respective location, based on the first number of sensor nodes and a connectivity capacity of said second number of fog nodes, where the second number of fog nodes is determined to cover said first number of sensor nodes.

The sensor nodes transmit information to fog nodes which again transmit information to cloud.

S320: ranking said second number of fog nodes according to a conditional probability of failure for the second number of fog nodes, based on determined information about the second number of fog nodes and their respective location.

In one example, the second number of fog nodes may be ranked in a similar manner as described in previous sections.

An example of ranking fog nodes is further described in relation to text descriptive of FIG. 4, see “Example 2”.

S330: identifying a top ranked subset of said second number of fog nodes, based on said ranking of said second number of fog nodes.

For example, based on conditional probability the fog nodes are arranged in descending order. Assume the fog nodes number are [2,4,10,1,3,5,9,8,7,6].

S340: positioning a backup fog node at each location of the top ranked subset of the second number of fog nodes.

The backup fog nodes are typically positioned at each location of each of the second number of fog nodes comprised in the top ranked subset.

In one example, users may choose how many nodes to keep a back up for. In this example, if users choose to explicitly backup 3 nodes, then a back up for nodes for 2,4,10 are kept, and thus a backup fog node is placed at the respective position.

Additionally or alternatively, ranking S320 of the second number of fog nodes comprises randomly dividing the second number of fog nodes into sets of two fog node clusters each, and calculating conditional probability of failure for a first fog node cluster of each of said set of two fog node clusters.

Additionally or alternatively, ranking S320 of the second number of fog nodes further comprises performing weighted averaging S322 of said first fog node clusters, using the calculated conditional probability of failure for said first fog node clusters, as weighting factors, creating averaged fog node clusters.

Additionally or alternatively, performing weighted averaging S322 of said fog node clusters further comprises iteratively performing: calculating S323 the conditional probability for failure for each, potentially averaged, fog node cluster, identifying S324 the, potentially averaged, fog node cluster having the lowest conditional probability for failure and replacing S325 said identified, potentially averaged, fog node cluster with the averaged fog node cluster that was last created.

Additionally or alternatively, the method further comprises identifying S326 the fog node cluster for which the conditional probability for failure is the highest, said fog node cluster comprising various proportions of the first number of fog nodes, and wherein ranking S320 of the first number of fog nodes comprises ranking the first number of fog nodes according to their respective proportion in the cluster having the highest conditional probability for failure.

Additionally or alternatively, identifying S330 the top ranked subset of said first number of fog nodes, comprising identifying the top subset of respective proportion of the first number of fog nodes.

Additionally or alternatively, obtaining S300 a first number of sensor nodes and their respective locations, comprises obtaining S302 a backup sensor node for each sensor node of a subset of the first number of the sensor nodes.

In a further aspect of the disclosure, a cloud node 104 in a communications system 100 is provided, wherein the communications system 100 comprises a plurality of sensor nodes 110 located at a plurality of locations, to be handled by fog nodes 120, wherein the cloud node 104 is adapted to:
obtain a first number, out of said plurality, of sensor nodes 110 and their respective locations, to monitor the communications system in its entirety, based on measurements from at least some of the plurality of sensor nodes at, at least some of the plurality of locations;
determine a second number of said fog nodes and their respective location, based on the first number of sensor nodes and on a connectivity capacity of said fog nodes, where the second number of fog nodes is determined to cover said first number of sensor nodes;
rank said second number of fog nodes according to a conditional probability of failure for the second number of fog nodes, based on determined information about the second number of fog nodes and their respective location; and
identify a top ranked subset of said second number of fog nodes, based on the ranked second number of fog nodes; and
position a backup fog node at each location of the top ranked subset of the second number of fog nodes.

Additionally or alternatively, the cloud node is further adapted to determine the second number of fog nodes to monitor said first number of sensor nodes, with the condition that the number of possible connections to sensor nodes is constrained to said connectivity capacity of said fog nodes.

Additionally or alternatively, the cloud node 104 is further adapted to randomly divide the second number of fog nodes into sets of two clusters each, and calculate conditional probability of failure for a first fog node cluster of each of said sets of two fog node clusters.

Additionally or alternatively, the cloud node is further adapted to comprise a weighted average of said first fog node clusters, using the calculated conditional probability for failure for said first fog node clusters, as weighting factors, and to create averaged fog node clusters.

Additionally or alternatively, the cloud node is further adapted to iteratively perform: calculate the conditional probability for failure for the each, potentially averaged, fog node cluster, identify the, potentially averaged, fog node cluster having the lowest conditional probability for failure and replace said identified, potentially averaged, fog node cluster with the averaged fog node cluster that was last created.

Additionally or alternatively, the cloud node is further adapted to identify the fog node cluster for which the conditional probability for failure is the highest, said for node cluster comprising various proportions of the first number of fog nodes, and to rank the first number of fog nodes according to their respective proportion in the fro node cluster having the highest conditional probability for failure.

Additionally or alternatively, the cloud node is further adapted to identify the top subset of respective proportion of the first number of fog nodes.

Additionally or alternatively, the cloud node is further adapted to obtain a backup sensor node for each sensor node of a subset of the first number of the sensor nodes.

In a further aspect of the disclosure, a computer program comprising instructions is provided, which, when executed on at least one processor QQ170, cause the at least one processor QQ170 to carry out any of the method steps described herein.

In a further aspect of the disclosure, a carrier comprising the computer program above is provided, wherein the carrier is one of an electronic signal, optical signal, radio signal or computer readable storage medium.

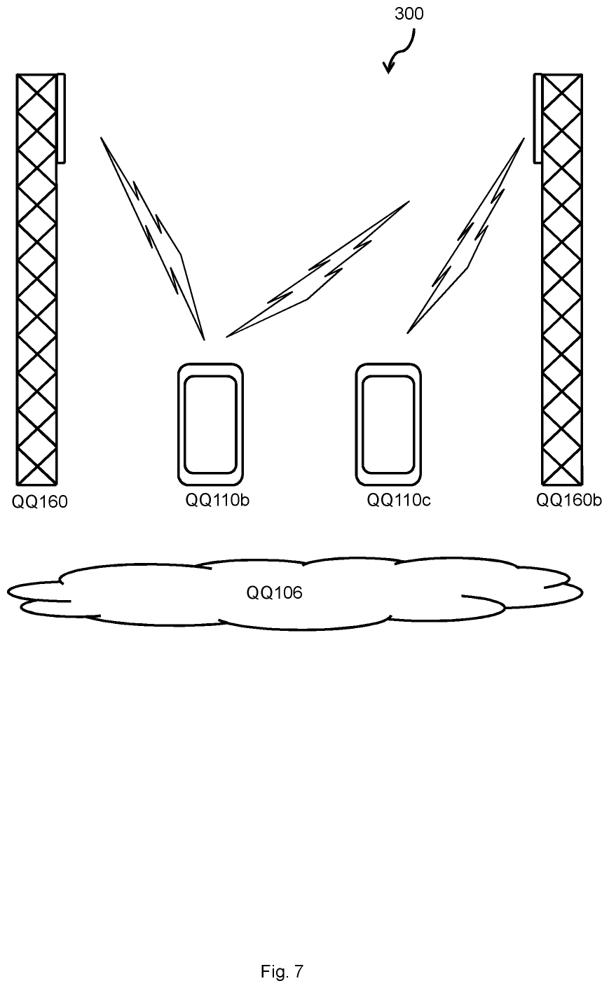

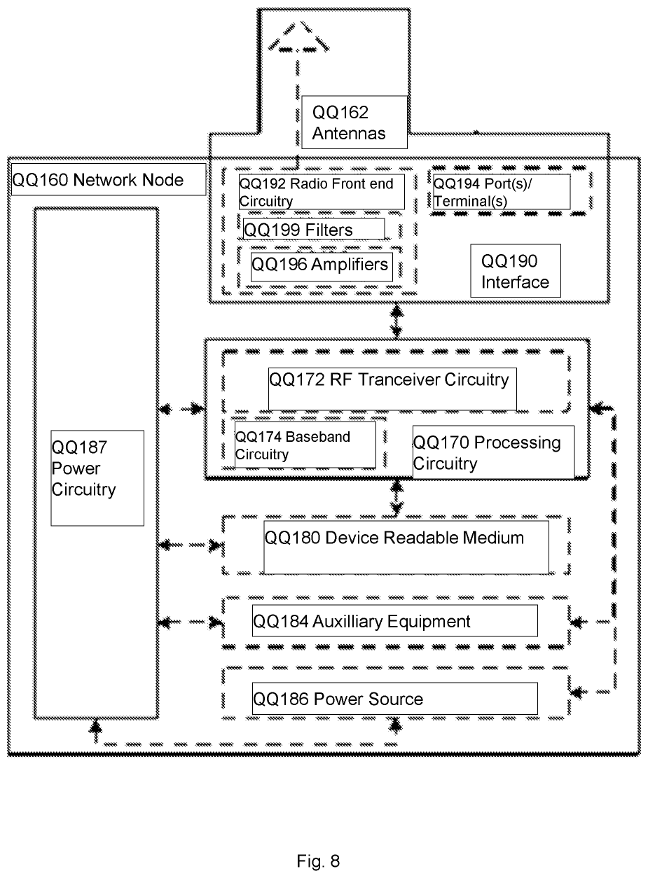

FIG. 7 shows an example of a network, in the form of a wireless network QQ106, in accordance with some embodiments of the present disclosure. Although the subject matter described herein may be implemented in any appropriate type of system using any suitable components, the embodiments disclosed herein are described in relation to a wireless network. For simplicity, the wireless network of FIG. 7 only depicts network QQ106 base stations/network nodes QQ160 and QQ160b, and wireless Devices WDs or UEs QQ110, QQ110b, and QQ110c. In practice, a network or wireless network may further include any additional elements suitable to support communication between wireless devices or between a wireless device and another communication device, such as a landline telephone, a service provider, or any other network node or end device. Of the illustrated components, network node QQ160 and wireless device, WD, QQ110 are depicted with additional detail in FIGS. 8 and 10 respectively. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS),

Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network QQ106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node QQ160 and WD QQ110 comprise various components described in more detail in FIGS. 8 and 10. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, node/base station/network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, and evolved Node Bs (eNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

FIG. 8 shows details of a node in the form of a network node QQ160 according to one or more embodiments. In FIG. 8, network node QQ160 includes processing circuitry QQ170, device readable medium QQ180, interface QQ190, auxiliary equipment QQ184, power source QQ186, power circuitry QQ187, and antenna QQ162. Although network node QQ160 illustrated in the example wireless network of FIG. 8 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node QQ160 are depicted as single boxes located within a larger box, or nested within multiple boxes, in practice, a network node may comprise multiple different physical components that make up a single illustrated component (e.g., device readable medium QQ180 may comprise multiple separate hard drives as well as multiple RAM modules).

Similarly, network node QQ160 may be composed of multiple physically separate components (e.g., a NodeB component and a RNC component, or a BTS component and a BSC component, etc.), which may each have their own respective components. In certain scenarios in which network node QQ160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node QQ160 may be configured to support multiple radio access technologies (RATs). In such embodiments, some components may be duplicated (e.g., separate device readable medium QQ180 for the different RATs) and some components may be reused (e.g., the same antenna QQ162 may be shared by the RATs). Network node QQ160 may also include multiple sets of the various illustrated components for different wireless technologies integrated into network node QQ160, such as, for example, GSM, WCDMA, LTE, NR, WiFi, or Bluetooth wireless technologies. These wireless technologies may be integrated into the same or different chip or set of chips and other components within network node QQ160.

Processing circuitry QQ170 is configured to perform any determining, calculating, or similar operations (e.g., certain obtaining operations) described herein as being provided by a network node. These operations performed by processing circuitry QQ170 may include processing information obtained by processing circuitry QQ170 by, for example, converting the obtained information into other information, comparing the obtained information or converted information to information stored in the network node, and/or performing one or more operations based on the obtained information or converted information, and as a result of said processing making a determination.

Processing circuitry QQ170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ160 components, such as device readable medium QQ180, network node QQ160 functionality. For example, processing circuitry QQ170 may execute instructions stored in device readable medium QQ180 or in memory within processing circuitry QQ170. Such functionality may include providing any of the various wireless features, functions, or benefits discussed herein. In some embodiments, processing circuitry QQ170 may include a system on a chip (SOC).

In some embodiments, processing circuitry QQ170 may include one or more of radio frequency (RF) transceiver circuitry QQ172 and baseband processing circuitry QQ174. In some embodiments, radio frequency (RF) transceiver circuitry QQ172 and baseband processing circuitry QQ174 may be on separate chips (or sets of chips), boards, or units, such as radio units and digital units. In alternative embodiments, part or all of RF transceiver circuitry QQ172 and baseband processing circuitry QQ174 may be on the same chip or set of chips, boards, or units

In certain embodiments, some or all of the functionality described herein as being provided by a network node, base station, eNB or other such network device may be performed by processing circuitry QQ170 executing instructions stored on device readable medium QQ180 or memory within processing circuitry QQ170. In alternative embodiments, some or all of the functionality may be provided by processing circuitry QQ170 without executing instructions stored on a separate or discrete device readable medium, such as in a hard-wired manner. In any of those embodiments, whether executing instructions stored on a device readable storage medium or not, processing circuitry QQ170 can be configured to perform the described functionality. The benefits provided by such functionality are not limited to processing circuitry QQ170 alone or to other components of network node QQ160, but are enjoyed by network node QQ160 as a whole, and/or by end users and the wireless network generally.

Device readable medium QQ180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry QQ170. Device readable medium QQ180 may store any suitable instructions, data or information, including a computer program, software, an application including one or more of logic, rules, code, tables, etc. and/or other instructions capable of being executed by processing circuitry QQ170 and, utilized by network node QQ160. Device readable medium QQ180 may be used to store any calculations made by processing circuitry QQ170 and/or any data received via interface QQ190. In some embodiments, processing circuitry QQ170 and device readable medium QQ180 may be considered to be integrated.

Interface QQ190 is used in the wired or wireless communication of signaling and/or data between network node QQ160, network QQ106, and/or WDs QQ110. As illustrated, interface QQ190 comprises port(s)/terminal(s) QQ194 to send and receive data, for example to and from network QQ106 over a wired connection. Interface QQ190 also includes radio front end circuitry QQ192 that may be coupled to, or in certain embodiments a part of, antenna QQ162. Radio front end circuitry QQ192 comprises filters QQ198 and amplifiers QQ196. Radio front end circuitry QQ192 may be connected to antenna QQ162 and processing circuitry QQ170. Radio front end circuitry may be configured to condition signals communicated between antenna QQ162 and processing circuitry QQ170. Radio front end circuitry QQ192 may receive digital data that is to be sent out to other network nodes or WDs via a wireless connection. Radio front end circuitry QQ192 may convert the digital data into a radio signal having the appropriate channel and bandwidth parameters using a combination of filters QQ198 and/or amplifiers QQ196. The radio signal may then be transmitted via antenna QQ162. Similarly, when receiving data, antenna QQ162 may collect radio signals which are then converted into digital data by radio front end circuitry QQ192. The digital data may be passed to processing circuitry QQ170. In other embodiments, the interface may comprise different components and/or different combinations of components.

In certain alternative embodiments, network node QQ160 may not include separate radio front end circuitry QQ192, instead, processing circuitry QQ170 may comprise radio front end circuitry and may be connected to antenna QQ162 without separate radio front end circuitry QQ192. Similarly, in some embodiments, all or some of RF transceiver circuitry QQ172 may be considered a part of interface QQ190. In still other embodiments, interface QQ190 may include one or more ports or terminals QQ194, radio front end circuitry QQ192, and RF transceiver circuitry QQ172, as part of a radio unit (not shown), and interface QQ190 may communicate with baseband processing circuitry QQ174, which is part of a digital unit (not shown).

Antenna QQ162 may include one or more antennas, or antenna arrays, configured to send and/or receive wireless signals. Antenna QQ162 may be coupled to radio front end circuitry QQ190 and may be any type of antenna capable of transmitting and receiving data and/or signals wirelessly. In some embodiments, antenna QQ162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna QQ162 may be separate from network node QQ160 and may be connectable to network node QQ160 through an interface or port.

Antenna QQ162, interface QQ190, and/or processing circuitry QQ170 may be configured to perform any receiving operations and/or certain obtaining operations described herein as being performed by a network node. Any information, data and/or signals may be received from a wireless device, another network node and/or any other network equipment. Similarly, antenna QQ162, interface QQ190, and/or processing circuitry QQ170 may be configured to perform any transmitting operations described herein as being performed by a network node. Any information, data and/or signals may be transmitted to a wireless device, another network node and/or any other network equipment.

Power circuitry QQ187 may comprise, or be coupled to, power management circuitry and is configured to supply the components of network node QQ160 with power for performing the functionality described herein. Power circuitry QQ187 may receive power from power source QQ186. Power source QQ186 and/or power circuitry QQ187 may be configured to provide power to the various components of network node QQ160 in a form suitable for the respective components (e.g., at a voltage and current level needed for each respective component). Power source QQ186 may either be included in, or external to, power circuitry QQ187 and/or network node QQ160. For example, network node QQ160 may be connectable to an external power source (e.g., an electricity outlet) via an input circuitry or interface such as an electrical cable, whereby the external power source supplies power to power circuitry QQ187. As a further example, power source QQ186 may comprise a source of power in the form of a battery or battery pack which is connected to, or integrated in, power circuitry QQ187. The battery may provide backup power should the external power source fail. Other types of power sources, such as photovoltaic devices, may also be used.

Alternative embodiments of network node QQ160 may include additional components beyond those shown in FIG. 8 that may be responsible for providing certain aspects of the network node's functionality, including any of the functionality described herein and/or any functionality necessary to support the subject matter described herein. For example, network node QQ160 may include user interface equipment to allow input of information into network node QQ160 and to allow output of information from network node QQ160. This may allow a user to perform diagnostic, maintenance, repair, and other administrative functions for network node QQ160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc.. A WD may support device-to-device (D2D) communication, for example by implementing a 3GPP standard for sidelink communication, and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as a machine-type communication (MTC) device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

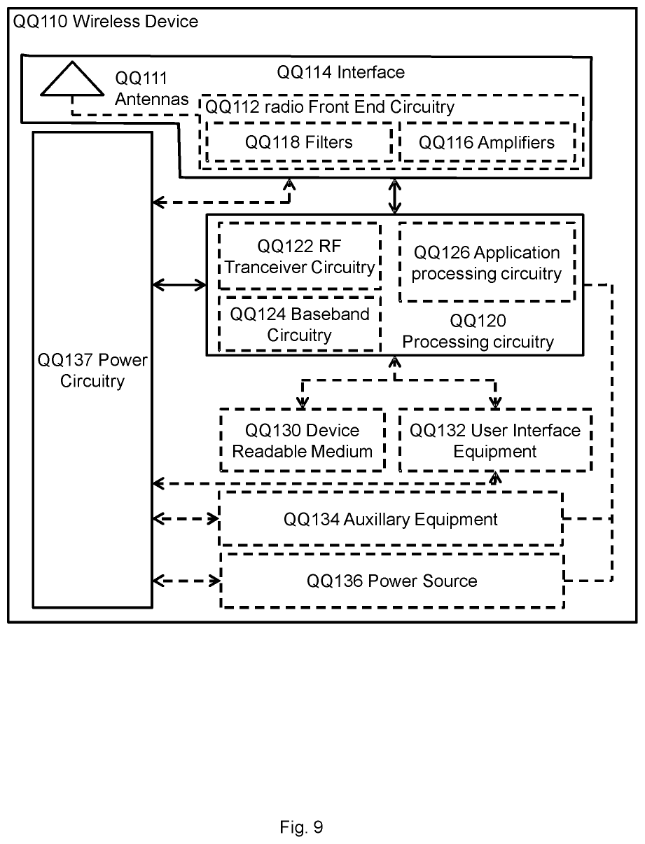

FIG. 9 shows details of a node in the form of a wireless device QQ110 according to one or more embodiments. As illustrated, wireless device QQ110 includes antenna QQ111, interface QQ114, processing circuitry QQ120, device readable medium QQ130, user interface equipment QQ132, auxiliary equipment QQ134, power source QQ136 and power circuitry QQ137. WD QQ110 may include multiple sets of one or more of the illustrated components for different wireless technologies supported by WD QQ110, such as, for example, GSM, WCDMA, LTE, NR, WiFi, WiMAX, or Bluetooth wireless technologies, just to mention a few. These wireless technologies may be integrated into the same or different chips or set of chips as other components within WD QQ110.

Antenna QQ111 may include one or more antennas or antenna arrays, configured to send and/or receive wireless signals, and is connected to interface QQ114. In certain alternative embodiments, antenna QQ111 may be separate from WD QQ110 and be connectable to WD QQ110 through an interface or port. Antenna QQ111, interface QQ114, and/or processing circuitry QQ120 may be configured to perform any receiving or transmitting operations described herein as being performed by a WD. Any information, data and/or signals may be received from a network node and/or another WD. In some embodiments, radio front end circuitry and/or antenna QQ111 may be considered an interface.

As illustrated, interface QQ114 comprises radio front end circuitry QQ112 and antenna QQ111. Radio front end circuitry QQ112 comprise one or more filters QQ118 and amplifiers QQ116. Radio front end circuitry QQ114 is connected to antenna QQ111 and processing circuitry QQ120, and is configured to condition signals communicated between antenna QQ111 and processing circuitry QQ120. Radio front end circuitry QQ112 may be coupled to or a part of antenna QQ111. In some embodiments, WD QQ110 may not include separate radio front end circuitry QQ112; rather, processing circuitry QQ120 may comprise radio front end circuitry and may be connected to antenna QQ111. Similarly, in some embodiments, some or all of RF transceiver circuitry QQ122 may be considered a part of interface QQ114. Radio front end circuitry QQ112 may receive digital data that is to be sent out to other network nodes or WDs via a wireless connection. Radio front end circuitry QQ112 may convert the digital data into a radio signal having the appropriate channel and bandwidth parameters using a combination of filters QQ118 and/or amplifiers QQ116. The radio signal may then be transmitted via antenna QQ111. Similarly, when receiving data, antenna QQ111 may collect radio signals which are then converted into digital data by radio front end circuitry QQ112. The digital data may be passed to processing circuitry QQ120. In other embodiments, the interface may comprise different components and/or different combinations of components.

Processing circuitry QQ120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD QQ110 components, such as device readable medium QQ130, WD QQ110 functionality. Such functionality may include providing any of the various wireless features or benefits discussed herein. For example, processing circuitry QQ120 may execute instructions stored in device readable medium QQ130 or in memory within processing circuitry QQ120 to provide the functionality disclosed herein.

As illustrated, processing circuitry QQ120 includes one or more of RF transceiver circuitry QQ122, baseband processing circuitry QQ124, and application processing circuitry QQ126. In other embodiments, the processing circuitry may comprise different components and/or different combinations of components. In certain embodiments processing circuitry QQ120 of WD QQ110 may comprise a SOC. In some embodiments, RF transceiver circuitry QQ122, baseband processing circuitry QQ124, and application processing circuitry QQ126 may be on separate chips or sets of chips. In alternative embodiments, part or all of baseband processing circuitry QQ124 and application processing circuitry QQ126 may be combined into one chip or set of chips, and RF transceiver circuitry QQ122 may be on a separate chip or set of chips. In still alternative embodiments, part or all of RF transceiver circuitry QQ122 and baseband processing circuitry QQ124 may be on the same chip or set of chips, and application processing circuitry QQ126 may be on a separate chip or set of chips. In yet other alternative embodiments, part or all of RF transceiver circuitry QQ122, baseband processing circuitry QQ124, and application processing circuitry QQ126 may be combined in the same chip or set of chips. In some embodiments, RF transceiver circuitry QQ122 may be a part of interface QQ114. RF transceiver circuitry QQ122 may condition RF signals for processing circuitry QQ120.

In certain embodiments, some or all of the functionality described herein as being performed by a WD may be provided by processing circuitry QQ120 executing instructions stored on device readable medium QQ130, which in certain embodiments may be a computer-readable storage medium. In alternative embodiments, some or all of the functionality may be provided by processing circuitry QQ120 without executing instructions stored on a separate or discrete device readable storage medium, such as in a hard-wired manner. In any of those particular embodiments, whether executing instructions stored on a device readable storage medium or not, processing circuitry QQ120 can be configured to perform the described functionality. The benefits provided by such functionality are not limited to processing circuitry QQ120 alone or to other components of WD QQ110, but are enjoyed by WD QQ110 as a whole, and/or by end users and the wireless network generally.

Processing circuitry QQ120 may be configured to perform any determining, calculating, or similar operations (e.g., certain obtaining operations) described herein as being performed by a WD. These operations, as performed by processing circuitry QQ120, may include processing information obtained by processing circuitry QQ120 by, for example, converting the obtained information into other information, comparing the obtained information or converted information to information stored by WD QQ110, and/or performing one or more operations based on the obtained information or converted information, and as a result of said processing making a determination.

Device readable medium QQ130 may be operable to store a computer program, software, an application including one or more of logic, rules, code, tables, etc. and/or other instructions capable of being executed by processing circuitry QQ120. Device readable medium QQ130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry QQ120. In some embodiments, processing circuitry QQ120 and device readable medium QQ130 may be considered to be integrated.

User interface equipment QQ132 may provide components that allow for a human user to interact with WD QQ110. Such interaction may be of many forms, such as visual, audial, tactile, etc. User interface equipment QQ132 may be operable to produce output to the user and to allow the user to provide input to WD QQ110. The type of interaction may vary depending on the type of user interface equipment QQ132 installed in WD QQ110. For example, if WD QQ110 is a smart phone, the interaction may be via a touch screen; if WD QQ110 is a smart meter, the interaction may be through a screen that provides usage (e.g., the number of gallons used) or a speaker that provides an audible alert (e.g., if smoke is detected). User interface equipment QQ132 may include input interfaces, devices and circuits, and output interfaces, devices and circuits. User interface equipment QQ132 is configured to allow input of information into WD QQ110, and is connected to processing circuitry QQ120 to allow processing circuitry QQ120 to process the input information. User interface equipment QQ132 may include, for example, a microphone, a proximity or other sensor, keys/buttons, a touch display, one or more cameras, a USB port, or other input circuitry. User interface equipment QQ132 is also configured to allow output of information from WD QQ110, and to allow processing circuitry QQ120 to output information from WD QQ110. User interface equipment QQ132 may include, for example, a speaker, a display, vibrating circuitry, a USB port, a headphone interface, or other output circuitry. Using one or more input and output interfaces, devices, and circuits, of user interface equipment QQ132, WD QQ110 may communicate with end users and/or the wireless network, and allow them to benefit from the functionality described herein.

Auxiliary equipment QQ134 is operable to provide more specific functionality which may not be generally performed by WDs. This may comprise specialized sensors for doing measurements for various purposes, interfaces for additional types of communication such as wired communications etc. The inclusion and type of components of auxiliary equipment QQ134 may vary depending on the embodiment and/or scenario.

Power source QQ136 may, in some embodiments, be in the form of a battery or battery pack. Other types of power sources, such as an external power source (e.g., an electricity outlet), photovoltaic devices or power cells, may also be used. WD QQ110 may further comprise power circuitry QQ137 for delivering power from power source QQ136 to the various parts of WD QQ110 which need power from power source QQ136 to carry out any functionality described or indicated herein. Power circuitry QQ137 may in certain embodiments comprise power management circuitry. Power circuitry QQ137 may additionally or alternatively be operable to receive power from an external power source; in which case WD QQ110 may be connectable to the external power source (such as an electricity outlet) via input circuitry or an interface such as an electrical power cable. Power circuitry QQ137 may also in certain embodiments be operable to deliver power from an external power source to power source QQ136. This may be, for example, for the charging of power source QQ136. Power circuitry QQ137 may perform any formatting, converting, or other modification to the power from power source QQ136 to make the power suitable for the respective components of WD QQ110 to which power is supplied.

Finally, it should be understood that the invention is not limited to the embodiments described above, but also relates to and incorporates all embodiments within the scope of the appended independent claims.

1. A method performed by a cloud node for handling sensor nodes and fog nodes in a communications system, wherein the communications system comprises a plurality of sensor nodes located at a plurality of locations, to be handled by the fog nodes the method comprising:
obtaining a first number of sensor nodes and their respective locations, out of said plurality of sensor nodes, to monitor the communications system in its entirety, based on measurements from at least some of the plurality of sensor nodes at their respective locations;
determining a second number of said fog nodes and their respective location, based on the first number of sensor nodes and a connectivity capacity of said second number of fog nodes, where the second number of fog nodes is determined to cover said first number of sensor nodes;
ranking said second number of fog nodes according to a conditional probability of failure for the second number of fog nodes, based on determined information about the second number of fog nodes and their respective location; and
identifying a top ranked subset of said second number of fog nodes, based on said ranking of said second number of fog nodes; and
positioning a backup fog node at each location of the top ranked subset of the second number of fog nodes.

2. The method according to claim 1, wherein ranking of the second number of fog nodes comprises randomly dividing the second number of fog nodes into sets of two fog node clusters each, and calculating conditional probability of failure for a first fog node cluster of each of said set of two fog node clusters.

3. The method according to claim 2, wherein ranking of the second number of fog nodes further comprises performing weighted averaging of said first fog node clusters, using the calculated conditional probability of failure for said first fog node clusters, as weighting factors, creating averaged fog node clusters.

4. The method according to claim 3, wherein performing weighted averaging of said fog node clusters further comprises iteratively performing: calculating the conditional probability for failure for each, potentially averaged, fog node cluster, identifying the, potentially averaged, fog node cluster having the lowest conditional probability for failure and replacing said identified, potentially averaged, fog node cluster with the averaged fog node cluster that was last created.

5. The method according to claim 4, further comprising identifying the fog node cluster for which the conditional probability for failure is the highest, said fog node cluster comprising various proportions of the first number of fog nodes, and wherein ranking of the first number of fog nodes comprises ranking the first number of fog nodes according to their respective proportion in the cluster having the highest conditional probability for failure.

6. The method according to claim 5, wherein identifying the top ranked subset of said first number of fog nodes, comprises identifying the top subset of respective proportion of the first number of fog nodes.

7. The method according to claim 1, wherein obtaining a first number of sensor nodes and their respective locations, comprises obtaining a backup sensor node for each sensor node of a subset of the first number of the sensor nodes.

8. A cloud node in a communications system, wherein the communications system comprises a plurality of sensor nodes located at a plurality of locations, to be handled by fog nodes, wherein the cloud node is adapted to:
obtain a first number, out of said plurality, of sensor nodes and their respective locations, to monitor the communications system in its entirety, based on measurements from at least some of the plurality of sensor nodes at, at least some of the plurality of locations;
determine a second number of said fog nodes and their respective location, based on the first number of sensor nodes and on a connectivity capacity of said fog nodes, where the second number of fog nodes is determined to cover said first number of sensor nodes;
rank said second number of fog nodes according to a conditional probability of failure for the second number of fog nodes, based on determined information about the second number of fog nodes and their respective location;
identify a top ranked subset of said second number of fog nodes, based on the ranked second number of fog nodes; and
position a backup fog node at each location of the top ranked subset of the second number of fog nodes.

9. The cloud node according to claim 8, further being adapted to determine the second number of fog nodes to monitor said first number of sensor nodes, with the condition that the number of possible connections to sensor nodes is constrained to said connectivity capacity of said fog nodes.

10. The cloud node according to claim 8, further being adapted to randomly divide the second number of fog nodes into sets of two clusters each, and calculate conditional probability of failure for a first fog node cluster of each of said sets of two fog node clusters.

11. The cloud node according to claim 10, further being adapted to weight average said first fog node clusters, using the calculated conditional probability for failure for said first fog node clusters, as weighting factors, and to create averaged fog node clusters.

12. The cloud node according to claim 11, further being adapted to iteratively perform: calculate the conditional probability for failure for the each, potentially averaged, fog node cluster, identify the, potentially averaged, fog node cluster having the lowest conditional probability for failure and replace said identified, potentially averaged, fog node cluster with the averaged fog node cluster that was last created.

13. The cloud node according to claim 12, further being adapted to identify the fog node cluster for which the conditional probability for failure is the highest, said fog node cluster comprising various proportions of the first number of fog nodes, and to rank the first number of fog nodes according to their respective proportion in the fog node cluster having the highest conditional probability for failure.

14. The cloud node according to claim 13, further being adapted to identify the top subset of respective proportion of the first number of fog nodes.

15. The cloud node according to claim 8, further being adapted to obtain a backup sensor node for each sensor node of a subset of the first number of the sensor nodes.

16. A computer program product comprising a non-transitory computer readable medium storing instructions which, when executed on at least one processor, cause the at least one processor to carry out the method according to claim 1.

17. (canceled)
